(19) United States
(12) Patent Application Publication
(10) Pub. No.: US 2009/0214151 A1
(43) Pub. Date: Aug. 27, 2009

(54) High Speed Optical Switch

(75) Inventor: David A. Keeling, Savannah, GA (US)

Correspondence Address: MERCHANT & GOULD PC, P.O. BOX 2903, MINNEAPOLIS, MN, 55402-0903, US

(73) Assignee: Georgia Tech Research Corporation, Atlanta, GA (US)

(21) Appl. No.: 12/298,199

(22) PCT Filed: Apr. 26, 2006
(86) PCT No.: PCT/US06/16170

§ 371 Date: Feb. 26, 2009

(51) Int. Cl. G02F 1/295

(52) U.S. Cl. 385/8

(57) ABSTRACT

A high speed optical switch may include a plurality of pairs each having a length L_{π} that may be connected in series. All switching may be accomplished in the high speed optical switch by discharging one arm in a pair (e.g. a single L_{π}) at a time. L_{π} may refer to a guide length used to induce a relative π phase shift. Each of the plurality of pairs may have two arms with both arms being initially charged. If both arms in any give pair have the same state, (e.g. either charged, uncharged, or charging) a ‘1’ may be transmitted through that pair. If the arms are in opposite states, (e.g. charged or uncharged) a π phase shift may be produced and a ‘0’ may be transmitted through that pair. For example, a first pair in the series may be recharged while other pairs are using in switching.

This application is being filed on 26 Apr. 2006, in the name of Georgia Tech Research Corp., a U.S. national corporation, applicant for the designation of all countries except the US, and David A. Keeling, a U.S. citizen, applicant for the designation of the US only, and does not claim priority to any earlier filed application.

### BACKGROUND

Optical switches are used in optical commutation systems. In some situations, Mach-Zehnder Interferometers (MZI) are used in optical switches. MZI have at least two different light transmitting arms and utilize many different properties to change the different arms' light phase. For example, a phase shift of π is desired to transmit a zero due to waves in each arm canceling. Unfortunately, y-splitting is difficult to achieve with an MZI optical switch because the two arms do not divide the power equally leading to a 10 dB or greater power differential between 1's and 0's. In addition to asymmetric power splitting, refractive index modulation can lead to additional loss, preventing the light waves from both arms completely canceling. Another asymmetric power division effect is that some power will be radiated away resulting in imperfect cancellation. If this is not acceptable, a larger device using the MZI with directional couplers can be used for a nonblocking optical switch.

An MZI optical switch may use a thermo optic effect to induce a change in refractive index. The limitations on such devices are size and the switching times due to heating and cooling. The thermo optic effect is limited to switching on the order of 1 MHz. An electro optic effect, changing the refractive index by injecting carriers, is faster than the thermo optic effect. Carrier injection is usually achieved via an applied electric field from metal leads. Generally, carrier injection is used in p-i-n diodes that have switching speeds on the order of 1 ns, but if higher losses are acceptable, a p-i-n can operate at GHz frequencies. The switching speed limit is a result of minority carrier action in an intrinsic region. Another form of electro optic modulation is to use a pump laser to inject carriers. The pump lasers limits are the additional power, size, equipment, and costs associated with this configuration, but with theoretical switching times on the order of a picosecond.

### SUMMARY

A high speed optical switch may be provided. This Summary is provided to introduce a selection of concepts in a simplified form that are further described below in the Detailed Description. This Summary is not intended to identify key features or essential features of the claimed subject matter. Nor is this Summary intended to be used to limit the scope of the claimed subject matter.

In accordance with one embodiment, a method for providing high speed switching may comprise discharging a first arm in a first side of a switch and discharging a second arm in a second side of the switch. The method may further include charging the first arm and the second arm substantially simultaneously. In addition, the method may include discharging a third arm in one of the first side of the switch and the second side of the switch during a time period in which charging the first arm and the second arm substantially simultaneously is conducted.

According to another embodiment, a system for providing high speed switching may comprise a plurality of pairs configured to be initially charged, the plurality of pairs comprising a switch. The system may further include a first arm in a first side of the switch, the first arm configured to be discharged and a second arm in a second side of the switch, the second arm configured to be discharged. The system may also include a charging component configured to charge the first arm and the second arm substantially simultaneously. Moreover, the system may include a third arm in one of the first side of the switch and the second side of the switch, the third arm configured to be discharged during a time period in which charging the first arm and the second arm substantially simultaneously is conducted.

In accordance with yet another embodiment, a computer-readable medium is provided which stores a set of instructions which when executed performs a method for providing high speed switching. The method, executed by the set of instructions, may comprise discharging a first arm in a first side of a switch and discharging a second arm in a second side of the switch. The method may further include charging the first arm and the second arm substantially simultaneously. Moreover, the method may include discharging a third arm in one of the first side of the switch and the second side of the switch during a time period in which charging the first arm and the second arm substantially simultaneously is conducted.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a diagram illustrating a rib waveguide used for p-i-n diodes;

FIGS. 2A through 2D are diagrams illustrating a high speed optical switch; and

FIG. 3 is a flow chart of a method for providing high speed optical switching.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

High speed optical switching may be provided. Consistent with embodiments of the present invention, an optical switch may use a series of MZI structures with Y-branches utilizing the electro optic effect in p-i-n diodes. Consistent with embodiments of the present invention, using silicon may allow the optical switch to be integratable, available, and inexpensive. Conventional systems are composed of InP or a III-V compound doped with InP, which are more expensive, not readily available, and may not be fabricated on a silicon wafer.

Consistent with embodiments of the invention, the electro optic effect in silicon may be used. For silicon MZI used with embodiments of the invention, a silicon on insulator (SOI) configuration may be used for a high optical index contrast that may allow small bend radii. SOI may also allow for a sub-micron waveguide while maintaining single mode operation.

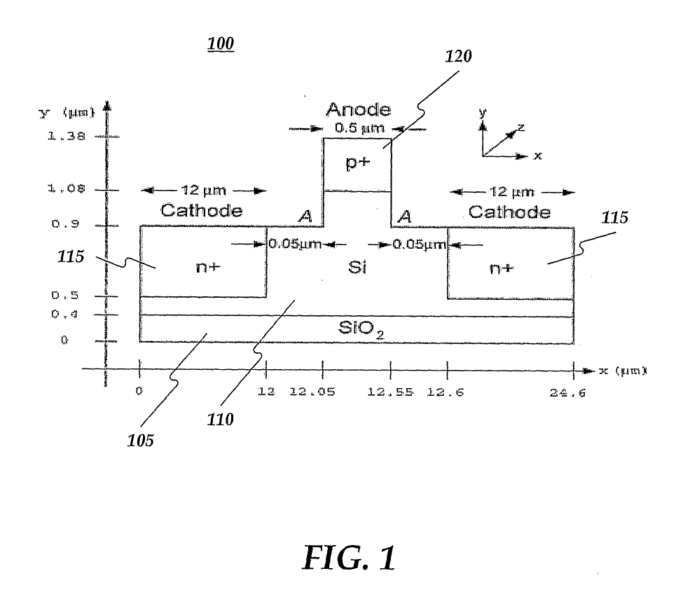

FIG. 1 is a diagram illustrating a rib waveguide 100 using p-i-n diodes consistent with embodiments of the invention. A p-i-n diode may comprise a semiconductor device that may operate as a variable resistor at radio and microwave frequencies using the aforementioned electro optic effect. Rib waveguide 100 may include an SiO₂ layer 105, an Si layer 110, cathodes 115 that may comprise an N material, and an anode 120 that may comprise a P material. For example, light may be propagated through Si layer 105. The light may be delayed or shifted by applying a voltage across cathodes 115 and anode 120. In other words, Si layer 110's refractive index may be adjusted by applying a voltage across cathodes 115 and anode 120 to “charge” the p-i-n diode. For example, rib waveguide 100's p-i-n diode's resistance value may be determined by a forward biased direct current created by the applied voltage. By controlling the p-i-n diode's resistance value, light propagated through Si layer 110 may be delayed or shifted, for example, by π (e.g. 180 degrees) by modulating Si layer 110's refractive index.

As stated above, consistent with embodiments of the present invention, an optical switch may use a series of MZI structures with Y-branches utilizing the aforementioned electro optic effect in p-i-n diodes. Each of the MZI structures may comprise a structure similar to that shown in FIG. 1 with Si layer 110 branching off into a Y-branch and then coming back together. Each side of branched Si layer 110 may be considered an “arm.” Each arm may be charged or discharged independently. In other words, light propagated through Si layer 110 may branch off at a first end of a Y-branch into each of two arms. The light from each arm may then come back together at a second end of the Y-branch. By using a voltage applied in the aforementioned process, light in either of the two arms may be delayed or shifted by π (e.g. 180 degrees) independently. Modulation of the refractive index of each arm may be governed by the following equations:

$$\begin{matrix}\begin{matrix}Δ n = Δ {n}_{e} + Δ {n}_{h} \\ = - 8.8 \times {10}^{- 22} ( Δ {N}_{e} ) - 8.5 \times {10}^{- 18} {( Δ {N}_{h} )}^{0.8}\end{matrix} & ( 1 ) \\ \begin{matrix}Δ α = Δ {α}_{e} + Δ {α}_{h} \\ = 8.5 \times {10}^{- 18} ( Δ {N}_{e} ) + 6.0 \times {10}^{- 18} ( Δ {N}_{h} )\end{matrix} & ( 2 )\end{matrix}$$

where:

λ freespace wavelength

Δn change in refractive index

Δnₑ, Δnₕ change in refractive index due to electrons and holes, respectively

ΔNₑ, ΔNₕ change in electron and hole concentration, respectively

Δα change in the absorption

Δαₑ, Δαₕ change in the absorption due to electrons and holes, respectively

The phase shift in an arm caused by the change in refractive index is characterized by

$$Δφ = \frac{2 π Δ nL}{λ} \qquad ( 3 )$$

To solve for L, substitute the desired phase shift, π, for Δφ

$${L}_{π} = \frac{λ}{2 Δ n} \qquad ( 4 )$$

With p-i-n diodes, the 0→1 transition time t₀₁ in a fast p-i-n diode MZI may be approximately 1 ns. The 1→0 transition time t₁₀, however, may be much faster, for example, approximately 0.15 ns. Due to the slower 0→1 transition time t₀₁, the switching speed of a conventional MZI may be too slow for gigabit operation.

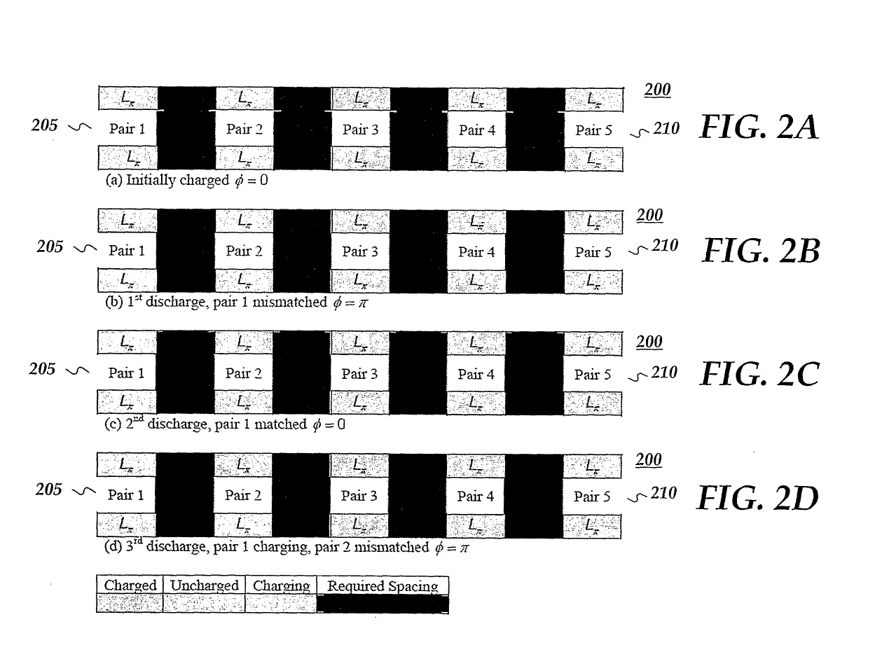

FIGS. 2A through 2D are diagrams illustrating a high speed optical switch 200 consistent with an embodiment of the invention. For example, embodiments of the invention may overcome p-i-n diode limitations caused by the slower 0→1 transition time t₀₁. To overcome the conventional system's slower switching transition time, consistent with embodiments of the invention, a plurality of pairs, each having a length L_{π}, may be connected in series (e.g. a pair 1, a pair 2, a pair 3, a pair 4, and a pair 5.) Each pair, for example, may comprise, but is not limited to an MZI. L_{π} may refer to a guide length used to induce a relative phase shift, for example, of π. Each of the plurality of pairs may have two arms with both arms being initially charged. If both arms in any give pair have the same state, (e.g. either charged, uncharged, or charging) a 1 may be transmitted through that pair. If the arms in any given pair are in opposite states (e.g. charged or uncharged) however, a π phase shift may be produced and a 0 may be transmitted through that pair.

Moreover, high speed optical switch 200 may include a first side and a second side. In the example shown in FIGS. 2A through 2D, the first side may comprising all the arms in the plurality of pairs that line up horizontally along the top of high speed optical switch 200. Similarly, the second side may comprise all the arms in the plurality of pairs that line up horizontally along the bottom of high speed optical switch 200.

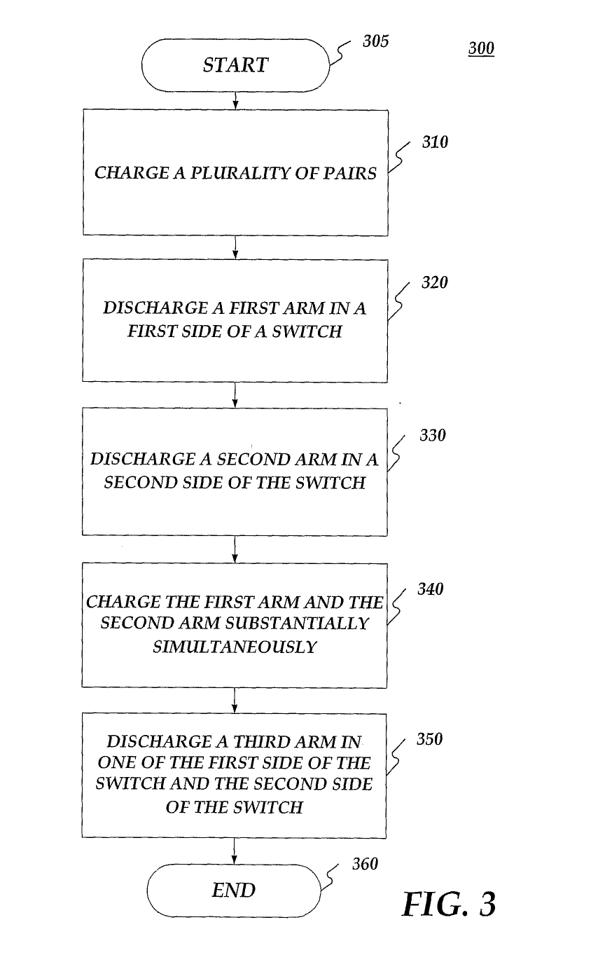

FIG. 3 is a flow chart setting forth the general stages involved in a method 300 consistent with an embodiment of the invention for providing high speed optical switching using system 200 of FIGS. 2A through 2D. Any suitable combination of hardware, software, and/or firmware may be used to drive high speed optical switch 200 by implementing, for example, method 300. Discrete electronic elements or microprocessors, for example, may be used along with high speed optical switching using system 200 to implement method 300. Ways to implement the stages of method 300 will be described in greater detail below.

Method 300 may begin at starting block 305. Consistent with an embodiment of the invention, the plurality of pairs in high speed optical switch 200 may be driven by an intelligent switching algorithm described, for example, in FIG. 3 in order to achieve faster switching times. For example, consistent with an embodiment of the invention, all switching may be accomplished in high speed optical switch 200 by discharging one arm in a pair (e.g. a single L_{π}) at a time.

As shown in FIG. 2A, high speed optical switch 200 may be initialized such that all of the plurality of pairs may be charged. (Stage 310.) When all of the plurality of pairs are charged, light may enter a first end 205 of high speed optical switch 200 and exit a second end 210. Consequently, a “1” may be transmitted by high speed optical switch 200.

As shown in FIG. 2B, high speed optical switch 200 may be switched from 1→0 by discharging a first L_{π} in one pair's arm, for example, pair 1. (Stage 320.) Because one arm in pair 1 has been discharged, the arms comprising pair 1 are in different states and a π phase shift may be present in high speed optical switch 200. Due to the π phase shift, light may enter first end 205 of high speed optical switch 200 may not exit second end 210. Consequently, a “0” may be transmitted by high speed optical switch 200.

As shown in FIG. 2C, high speed optical switch 200 may be switched from 0→1 by discharging an arm on a side of switch 200 opposite the arm discharged in stage 320 (e.g. the arm directly opposite the arm discharged in stage 320.) (Stage 330.) Consistent with embodiments of the invention, any opposite side arm in any pair may be discharged, and discharging is not limited to arms directly opposite each other. In other words, the arms charged and discharged do not need to be in the same pair, just on the different sides. Because the arms comprising pair 1 are in the same state (both discharged), a π phase shift may no longer present in high speed optical switch 200. Due to no phase shift being present, light may enter first end 205 of high speed optical switch 200 and may exit second end 210. Consequently, a “1” may be transmitted by high speed optical switch 200.

After both arms are discharged in stages 320 and 330, they can begin recharging simultaneously (stage 340) while adjacent pairs (e.g. pair 2), for example, may be used for switching. Once recharged, pair 1 can be used for switching again. Because the two discharged arms on opposite sides may be recharged substantially simultaneously, no phase shift is created in high speed optical switch 200 by the arms being recharged. Accordingly, the arms on opposite sides being recharged substantially simultaneously have no effect on switching being performed by high speed optical switch 200. While pair 1 is recharging, other pairs may be used for switching high speed optical switch 200.

As shown in FIG. 2D, high speed optical switch 200 may be switched from 1→0 by discharging an arm in another pair (e.g. pair 2.) (Stage 350.) Because the arms of pair 1 are being recharged substantially simultaneously, no phase shift is created in high speed optical switch 200 by pair 1. Furthermore, because one arm in pair 2 has been discharged, the arms comprising pair 2 are in different states and a π phase shift may be present in high speed optical switch 200. Due to the π phase shift, light entering first end 205 of high speed optical switch 200 may not exit second end 210. Consequently, a “0” may be transmitted by high speed optical switch 200.

Consistent with embodiments of the invention, because other pairs may be used for switching, the slower 0→1 transition time t₀₁ may not limit the overall switching time of high speed optical switch 200. For example, consistent with embodiments of the invention, all switching may be performed using the faster 1→0 transition time t₁₀. For the example given above, the maximum number of pairs may comprise 5, assuming, for example, negligible slot time. For a 400 ps slot time, only 2 pairs may be used and the switch may operate at 1.8 Gb/s.

If L, is too large, losses due to free carriers may be unacceptable. By choosing an aggressive Δn, 0.01, loss is decreased with respect to L_{π}, 7.75 um for the 1.55 communication wavelength. To achieve Δn=0.01, dopant concentrations may be high and the current required increases. Also from the design formulae, it is possible to choose the desired L_{π} and solve for Δn accordingly, as it is easier to change. This puts loss in the range of 16 dB/cm due to free carrier absorption for the distance traveled through the p-i-n diodes.

Furthermore, embodiments of the invention may be practiced using an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as show in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing high speed switching, the method comprising:
discharging a first arm in a first side of a switch;
discharging a second arm in a second side of the switch;
charging the first arm and the second arm substantially simultaneously; and
discharging a third arm in one of the first side of the switch and the second side of the switch during a time period in which charging the first arm and the second arm substantially simultaneously is conducted.

2. The method of claim 1, further comprising charging a plurality of pairs prior to discharging the first arm, the second arm, and the third arm, the plurality of pairs comprising the first arm, the second arm, and the third arm.

3. The method of claim 1, wherein the first arm and the second arm comprise a first pair.

4. The method of claim 1, wherein at least one of the following is included in one or more Mach-Zehnder Interferometers (MZI): the first arm, the second arm, and the third arm.

5. The method of claim 4, wherein the one or more Mach-Zehnder Interferometers (MZI) comprise a silicon on insulator (SOI) configuration.

6. The method of claim 1, wherein one of discharging the first arm, discharging the second arm, and discharging the third arm takes less time than one of charging the first arm and charging the second arm.

7. The method of claim 6, wherein one of discharging the first arm, discharging the second arm, and discharging the third arm is accomplished in less or equal to 0.15 ns.

8. The method of claim 6, wherein one of charging the first arm and charging the second arm is accomplished in greater or equal to 1 ns.

9. A system for providing high speed switching, the system comprising:
a plurality of pairs configured to be initially charged, the plurality of pairs comprising a switch;
a first arm in a first side of the switch, the first arm configured to be discharged;
a second arm in a second side of the switch, the second arm configured to be discharged;
a charging component configured to charge the first arm and the second arm substantially simultaneously; and
a third arm in one of the first side of the switch and the second side of the switch, the third arm configured to be discharged during a time period in which charging the first arm and the second arm substantially simultaneously is conducted.

10. The system of claim 9, wherein the first arm and the second arm comprise a first pair.

11. The system of claim 9, wherein at least one of the following is included in one or more Mach-Zehnder Interferometers (MZI): the first arm, the second arm, and the third arm.

12. The system of claim 11, wherein the one or more Mach-Zehnder Interferometers (MZI) comprise a silicon on insulator (SOI) configuration.

13. A computer-readable medium which stores a set of instructions which when executed performs a method for providing high speed switching, the method executed by the set of instructions comprising:
discharging a first arm in a first side of a switch;
discharging a second arm in a second side of the switch;
charging the first arm and the second arm substantially simultaneously; and
discharging a third arm in one of the first side of the switch and the second side of the switch during a time period in which charging the first arm and the second arm substantially simultaneously is conducted.

14. The computer-readable medium of claim 13, further comprising charging a plurality of pairs prior to discharging the first arm, the second arm, and the third arm, the plurality of pairs comprising the first arm, the second arm, and the third arm.

15. The computer-readable medium of claim 13, wherein the first arm and the second arm comprise a first pair.

16. The computer-readable medium of claim 13, wherein at least one of the following is included in one or more Mach-Zehnder Interferometers (MZI): the first arm, the second arm, and the third arm.

17. The computer-readable medium of claim 16, wherein the one or more Mach-Zehnder Interferometers (MZI) comprise a silicon on insulator (SOI) configuration.

18. The computer-readable medium of claim 13, wherein one of discharging the first arm, discharging the second arm, and discharging the third arm takes less time than one of charging the first arm and charging the second arm.

19. The computer-readable medium of claim 18, wherein one of discharging the first arm, discharging the second arm, and discharging the third arm is accomplished in less or equal to 0.15 ns.

20. The computer-readable medium of claim 18, wherein one of charging the first arm and charging the second arm is accomplished in greater or equal to 1 ns.
